(19) United States
(12) Patent Application Publication
(10) Pub. No.: US 2022/0408685 A1
(43) Pub. Date: Dec. 29, 2022

(54) Pop Up Kitty Bedroom Device

(71) Applicant: Traci Capaldo, Hamden, CT (US)

(72) Inventor: Traci Capaldo, Hamden, CT (US)

(21) Appl. No.: 17/734,134

(22) Filed: May 2, 2022

Related U.S. Application Data
(60) Provisional application No. 63/216,213, filed on Jun. 29, 2021.

(51) Int. Cl. A01K 1/03; A01K 1/035

(52) U.S. Cl. CPC A01K 1/033; A01K 1/035

(57) ABSTRACT

The present invention relates to a novel cat house device. The device is designed to provide cats with a large, cozy housing area for sleeping, eating, and/or playing. Specifically, the cat house device can be available in various sizes and shapes to house both cats and kittens of different breeds and/or sizes. The device comprises a pop-up structure which comprises a foam bed, a blanket, and additional accessories. The device can be compacted into an easy to carry device with a handle, when not in use.

### CROSS-REFERENCE TO RELATED APPLICATION

The present application claims priority to, and the benefit of, U.S. Provisional Application No. 63/216,213, which was filed on Jun. 29, 2021 and is incorporated herein by reference in its entirety.

### FIELD OF THE INVENTION

The present invention relates generally to the field of cat house devices. More specifically, the present invention relates to an improved cat house device that provides cats with a housing area for sleeping, eating, and/or playing. Specifically, the device comprises a pop-up structure with a foam bed and other accessories. Accordingly, the present disclosure makes specific reference thereto. Nonetheless, it is to be appreciated that aspects of the present invention are also equally applicable to other like applications, devices and methods of manufacture.

### BACKGROUND

By way of background, some cats enjoy having their own sleeping space, and even utilize beds, blankets, etc. Further, pet owners may want a unique, cozy, and fun bed area for their cats. Typically, cats enjoy utilizing their own area for sleeping, eating, playing, etc. A fun, entertaining and comfortable cat house for pet owners to give their cats would be advantageous.

Further, some pet accessories can be large, bulky, and difficult to transport. Additionally, conventional pet accessories are typically made out of large cardboard tubes which are not collapsible, or made out of rigid materials which are nailed, or adhesively bonded together, etc., to form a rigid box which does not collapse for storage and/or shipping. A large, cozy housing area for sleeping, eating, and/or playing that collapses for transportation and/or storage would be advantageous.

Therefore, a novel cat house device is needed that can provide pet owners with a unique, cozy and fun bed area for their cats. Further, a useful device is needed that is not made of rigid materials and can be collapsed for storage and/or transportation.

Therefore, there exists a long-felt need in the art for a cat house device that provides cats with a large, cozy, housing area for sleeping, eating, and/or playing. There is also a long-felt need in the art for a cat house device that includes a comfortable foam bed and a blanket for a cat to curl up and sleep in. Further, there is a long-felt need in the art for a cat house device that provides a plurality of accessories for the housing area, such as drawers for toys, windows, a swinging door, etc. Moreover, there is a long-felt need in the art for a device that allows each accessory to be secured to the housing area via hook and loop fasteners. Further, there is a long-felt need in the art for a cat house device that offers a fun, entertaining, and comfortable cat house for pet owners to give to their cats. Finally, there is a long-felt need in the art for a cat house device that can be compacted into an easy to carry device with a handle, when not in use.

The subject matter disclosed and claimed herein, in one embodiment thereof, comprises a cat house device. The device is designed to provide cats with a large, cozy housing area for sleeping, eating, and/or playing. Specifically, the cat house device can be available in various sizes and shapes to house both cats and kittens of different breeds and/or sizes. The device comprises a pop-up structure that houses a cat. The interior of the structure comprises a foam bed, a blanket, a foam dresser that holds cat toys, a battery-operated lamp, a scratchy rug, a swinging door, several windows, and food and water bowls. The structure may also comprise a plurality of decorations, photographs, or quotes that can be secured to the structure's walls via hook and loop fasteners.

In this manner, the cat house device of the present invention accomplishes all of the foregoing objectives and provides users with a device that offers a fun, entertaining and comfortable cat house. The device is available in various sizes and/or shapes for different breeds of cats. The device can be compacted into an easy to carry device with a handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cat house device. The device is designed to provide cats with a large, cozy housing area for sleeping, eating, and/or playing. Specifically, the device comprises a pop-up structure that houses a cat. The pop-up structure can be any suitable shape or size as is known in the art. Typically, the pop-up structure is rectangular in shape, but in other embodiments, the pop-up structure is square, oval, or circular, etc. In one embodiment, the cat house device can be available in various sizes and shapes to house both cats and kittens of different breeds and/or sizes, as well as other pets, such as small dogs, hamsters, rabbits, etc., as is known in the art.

In one embodiment, the pop-up structure can comprise a single rod or multi-rod frame or supporting structure arranged with single or multi-connectors, together with an attached fabric structure which forms a self-erecting pop-up structure. In the erected configuration, a base component is formed in a single horizontal plane with a wall component, comprising the walls of the structure, being formed above the base component. The walls of the structure are substantially vertical and extend upward from the base component. The two components are not symmetrical but can be symmetrical depending on the shape desired. The wall component is typically larger than the base component. The pop-up structure is self-erecting and foldable when not in use. The single wire or multi-wire or rods forming the pop-up structure's frame are joined together by a single connector or multi-connectors. The connectors provide for freedom of rotation of each end of the single rod or rods during the erecting and folding of the structure. The inherent spring characteristics of the wire or rod frame of the structure maintain the rigidity of the walls when in the popped-out position.

In another embodiment, the pop-up structure comprises a set of four rigid walls, secured to opposing sides of a rectangular floor component. The four rigid walls and floor component can be one integral piece, or separate components secured together. If one integral piece, the four rigid walls hinge at the base or floor component, allowing the four rigid walls to be folded in on each other to collapse the structure. Once erect, the four rigid walls are secured in a substantially vertical position via flaps positioned at the corners of the wall.

In another embodiment, the pop-up structure comprises a flexible base with a set of four rigid walls secured to the base. The four rigid walls comprise a crease or (a fold or indent) in at least two of the walls, which allows those two walls to fold in on themselves, and the adjacent walls to lay flat on the folded walls, compressing the structure into a flat, compacted, easy to carry structure. The walls are then unfolded in a substantially vertical position for use. Once erect, the four walls are held in the substantially vertical position via a rigid floor component which overlays the flexible base, providing rigidity to the structure and retaining the walls in an upright position.

In one embodiment, the interior of the pop-up structure comprises a foam bed, a blanket, a foam dresser that holds cat toys, a battery-operated lamp, a scratchy rug, a swinging door, several windows, and food and water bowls, etc., as well as any other suitable accessories as is known in the art, depending on the needs and/or wants of a user. Further, the plurality of accessories can be secured within the pop-up structure via hook and loop fasteners, or any other suitable securing means as is known in the art.

In one embodiment, the pop-up structure may also comprise a plurality of decorations, photographs, or quotes, etc., or any other suitable decorations that can be secured to the pop-up structure via hook and loop fasteners, or any other suitable securing means as is known in the art.

In one embodiment, when not in use, the cat house device is collapsible, such that the pop-up structure's walls fold in on each other, or coil together into a flat structure via the rod or multi-rod frame. Once collapsed, the cat house device comprises at least one handle, secured to the back of a wall for easy transportation when carrying the device.

In yet another embodiment, the cat house device is manufactured from cardboard, wood, metal, posterboard, nylon, fiberglass, heat-sealable plastic or polymers, such as polypropylene or acrylonitrile-butadiene-styrene (ABS), or other suitable materials as is known in the art. The plurality of accessories are manufactured from foam, cardboard, plastic, cotton fabric, etc., or any other suitable materials as is known in the art.

In one embodiment, the cat house device comprises a roof or ceiling component that encloses the pop-up structure.

In another embodiment, the cat house device comprises a plurality of indicia on the pop-up structure and/or the plurality of accessories.

In yet another embodiment, a method of providing cats with a large, cozy housing area for sleeping, eating, and/or playing is described. The method includes the steps of providing a pop-up structure for housing the cat, wherein the structure comprises a foam bed, a blanket, and other accessories. The method also comprises popping open the structure, such that a cat can sleep inside the structure. Further, the method comprises assembling the accessories inside the structure and securing the accessories via hook and loop fasteners. The method comprises allowing a cat to sleep, eat, and/or play inside the structure. Finally, collapsing the structure into an easy to carry device for transportation and/or storage, when not in use.

In yet another embodiment of the present invention, a cat house device is disclosed that offers a fun, entertaining and comfortable cat house. The device is available in various sizes and/or shapes for different breeds of cats. The device comprises a pop-up structure with a plurality of accessories, including a bed, a blanket, a swinging door, and food and water bowls. Once erect, the structure allows cats to enter the device and utilize the pop-up structure for sleeping, eating, and/or playing. When not in use, the device can be collapsed into a compact device with a handle for easy transportation and storage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the cat house device of the present invention disclosing the pop-up structure and internal components in accordance with the disclosed architecture;

FIG. 1B illustrates a perspective view of one potential embodiment of the cat house device of the present invention disclosing the pop-up structure and internal components in accordance with the disclosed architecture;

FIG. 1C illustrates a perspective view of one potential embodiment of the cat house device of the present invention disclosing the pop-up structure and internal components in accordance with the disclosed architecture;

FIG. 2 illustrates a perspective view of another embodiment of the cat house device of the present invention in use in accordance with the disclosed architecture;

FIG. 3 illustrates a perspective view showing how the cat house device can be compacted and transported via a handle when not in use in accordance with the disclosed architecture; and

FIG. 4 illustrates a flowchart showing the method of providing cats with a large, cozy housing area for sleeping, eating, and/or playing in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a cat house device that provides cats with a large, cozy, housing area for sleeping, eating, and/or playing. There is also a long-felt need in the art for a cat house device that includes a comfortable foam bed and a blanket for a cat to curl up and sleep in. Further, there is a long-felt need in the art for a cat house device that provides a plurality of accessories for the housing area, such as drawers for toys, windows, a swinging door, etc. Moreover, there is a long-felt need in the art for a device that allows each accessory to be secured to the housing area via hook and loop fasteners. Further, there is a long-felt need in the art for a cat house device that offers a fun, entertaining, and comfortable cat house for pet owners to give to their cats. Finally, there is a long-felt need in the art for a cat house device that can be compacted into an easy to carry device with a handle, when not in use.

The present invention, in one exemplary embodiment, is a novel cat house device that comprises a pop-up structure that houses a cat. Specifically, the cat house device can be available in various sizes and shapes to house both cats and kittens of different breeds and/or sizes. The interior of the structure comprises a foam bed, a blanket, and other accessories. Further, the device can be compacted into an easy to carry device with a handle. The present invention also includes a novel method of providing cats with a large, cozy housing area for sleeping, eating, and/or playing. The method includes the steps of providing a pop-up structure for housing the cat, wherein the structure comprises a foam bed, a blanket, and other accessories. The method also comprises popping open the structure, such that a cat can sleep inside the structure. Further, the method comprises assembling the accessories inside the structure and securing the accessories via hook and loop fasteners. The method comprises allowing a cat to sleep, eat, and/or play inside the structure. Finally, collapsing the structure into an easy to carry device for transportation and/or storage, when not in use.

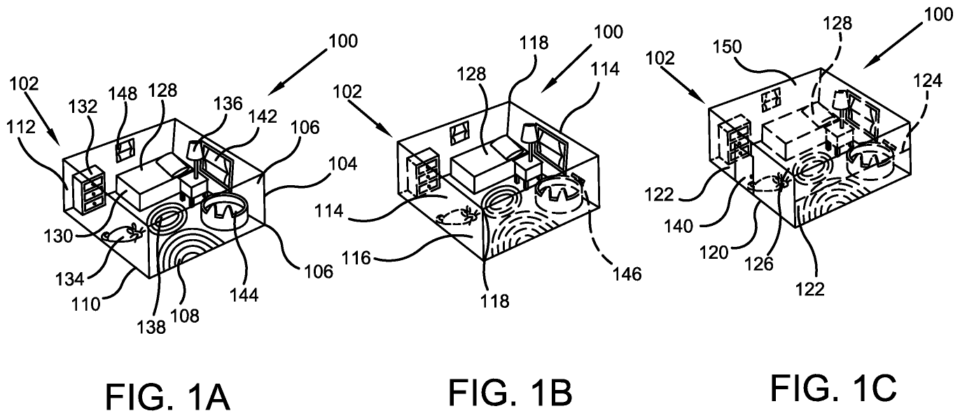

Referring initially to the drawings, FIG. 1A illustrates a perspective view of one embodiment of the cat house device 100 of the present invention. In the present embodiment, the cat house device 100 is an improved cat house device that provides cats with a large, cozy housing area for sleeping, eating, and/or playing. The device 100 is especially designed to allow any pet owner, of cats, kittens, or other suitable pets, etc., or any other suitable user as is known in the art, a fun, entertaining and comfortable cat house they can give their cats or other pets. The pets can be cats, kittens, small dogs, puppies, etc., or any other suitable pets as is known in the art, depending on the needs and/or wants of a user. More specifically, the device 100 comprises a pop-up structure 102 with a plurality of accessories positioned inside the structure 102.

In use, the device 100 comprises a pop-up structure 102 that houses a cat. The pop-up structure 102 can be any suitable shape or size as is known in the art. Typically, the pop-up structure 102 is rectangular in shape, but in other embodiments the pop-up structure 102 is square, oval, or circular, etc. In one embodiment, the cat house device 100 can be available in various sizes and shapes to house both cats and kittens of different breeds and/or sizes, as well as other suitable pets, such as small dogs, hamsters, rabbits, etc., as is known in the art.

The pop-up structure 102 of the cat house device 100 is able to be expanded for use by the pet owner and collapsed into a compact device when not in use. This expansion and/or compaction can be performed via any suitable means as is known in the art, depending on the needs and/or wants of a user. For example, in one embodiment, the pop-up structure 102 can comprise a single rod or multi-rod frame 104 or supporting structure arranged with single or multi-connectors 106, together with an attached fabric structure 108 which forms a self-erecting pop-up structure 102. In the erected configuration, a base component 110 is formed in a single horizontal plane with a wall component 112, comprising the walls 112 of the structure 102, being formed above the base component 110. The walls 112 of the structure 102 are substantially vertical and extend upward from the base component 110. The two components 110 and 112 are not symmetrical but can be symmetrical depending on the shape desired for the structure 102. The wall component 112 is typically larger than the base component 110. The pop-up structure 102 is self-erecting and foldable when not in use. The single wire or multi-wire or rods 104 forming the pop-up structure's frame are joined together by a single connector or multi-connectors 106. The connectors 106 provide for freedom of rotation of each end of the single rod or rods 104 during the erecting and folding of the structure 102. The inherent spring characteristics of the wire or rod frame 104 of the structure 102 maintains the rigidity of the walls 112 when in the popped-out position.

In another embodiment shown in FIG. 1B, the pop-up structure 102 comprises a set of four rigid walls 114, secured to opposing sides of a rectangular floor component 116. The four rigid walls 114 and floor component 116 can be one integral piece, or separate components secured together via rivets, glue, screw, etc. If one integral piece, the four rigid walls 114 hinge at the base or floor component 116, allowing the four rigid walls 114 to be folded in on each other to collapse the structure 102. Once erect, the four rigid walls 114 are secured in a substantially vertical position via flaps 118 positioned at the corners of the walls 114 which wrap around the corners, securing the walls 114 together.

In another embodiment shown in FIG. 1C, the pop-up structure 102 comprises a flexible base 120 with a set of four rigid walls 122 secured to the base 120. The four rigid walls 122 comprise a crease 124 (a fold or indent) in at least two of the walls 122, which allows those two walls 122 to fold in on themselves, and the adjacent walls 122 to lay flat on the folded walls 122, compressing the structure 102 into a flat, compacted, easy to carry structure 102. The walls 122 are then unfolded in a substantially vertical position for use. Once erect, the four walls 122 are held in the substantially vertical position via a rigid floor component 126 which overlays the flexible base 120, providing rigidity to the structure 102 and retaining the walls 122 in an upright position.

Furthermore, as shown in FIG. 1A, the interior of the pop-up structure 102 comprises a foam bed 128, a blanket 130, a foam dresser 132 that holds cat toys 134, a battery-operated lamp 136, a scratchy rug 138, a swinging door 140, several windows 142, and food and water bowls 144, etc., as well as any other suitable accessories as is known in the art, depending on the needs and/or wants of a user. Further, the plurality of accessories can be secured within the pop-up structure 102 via hook and loop fasteners 146, or any other suitable securing means as is known in the art, such as gluing, taping, screws, etc. The swinging door 140 would typically be secured to the pop-up structure 102 via hinges, living hinges, etc., or any other movable securing means as is known in the art. Further, the lamp 136 can be battery powered or electrical, or any other suitable power means as is known in the art.

Additionally, the pop-up structure 102 may also comprise a plurality of decorations 148, photographs, or quotes, etc., or any other suitable decorations 148 that can be secured to the pop-up structure 102 via hook and loop fasteners 146, or any other suitable securing means as is known in the art, such as gluing, taping, screws, etc.

In one embodiment, the cat house device 100 is manufactured from cardboard, wood, metal, posterboard, nylon, fiberglass, heat-sealable plastic or polymers, such as polypropylene or acrylonitrile-butadiene-styrene (ABS), acrylics, polycarbonate, polyethylene, polyethylene terephthalate, polyvinyl chloride, polystyrene, or other suitable materials as is known in the art. The plurality of accessories are manufactured from foam, cardboard, plastic, cotton fabric, etc., or any other suitable materials as is known in the art.

In one embodiment, the cat house device 100 comprises a roof or ceiling component 150 that encloses the pop-up structure 102. The ceiling component 150 would be secured via any suitable securing means as is known in the art, such as gluing, screws, taping, etc. Further, the ceiling component 150 would be manufactured from the same materials as the pop-up structure 102.

In another embodiment, the pop-up structure 102 of the cat house device 100 may include advertising, a trademark, or other letters, designs, or characters, printed, painted, stamped, or integrated into the pop-up structure 102 and/or the plurality of accessories, or any other indicia 152 as is known in the art. Specifically, any suitable indicia 152 as is known in the art can be included, such as but not limited to, patterns, logos, emblems, images, symbols, designs, letters, words, characters, animals, advertisements, brands, etc., that may or may not be pet or cat/brand related.

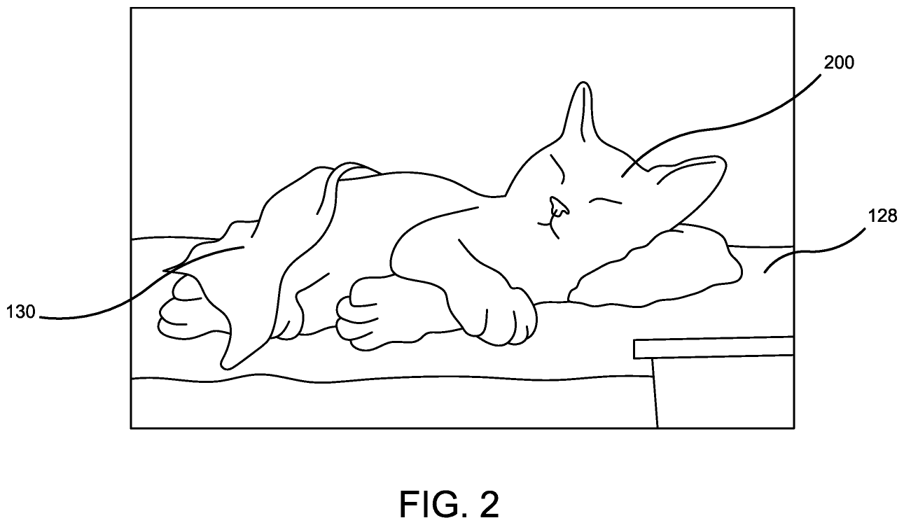

FIG. 2 illustrates a perspective view of another embodiment of the cat house device 100 of the present invention, wherein the device 100 offers a fun, entertaining and comfortable cat house. The device 100 is available in various sizes and/or shapes for different breeds of cats. The device 100 comprises a pop-up structure 102 with a plurality of accessories, including a bed, a blanket, a swinging door, and food and water bowls. Once erect, the structure 102 allows cats 200 to enter the device 100 and utilize the pop-up structure 102 for sleeping, eating, and/or playing. When not in use, the device 100 can be collapsed into a compact device with a handle for easy transportation and storage.

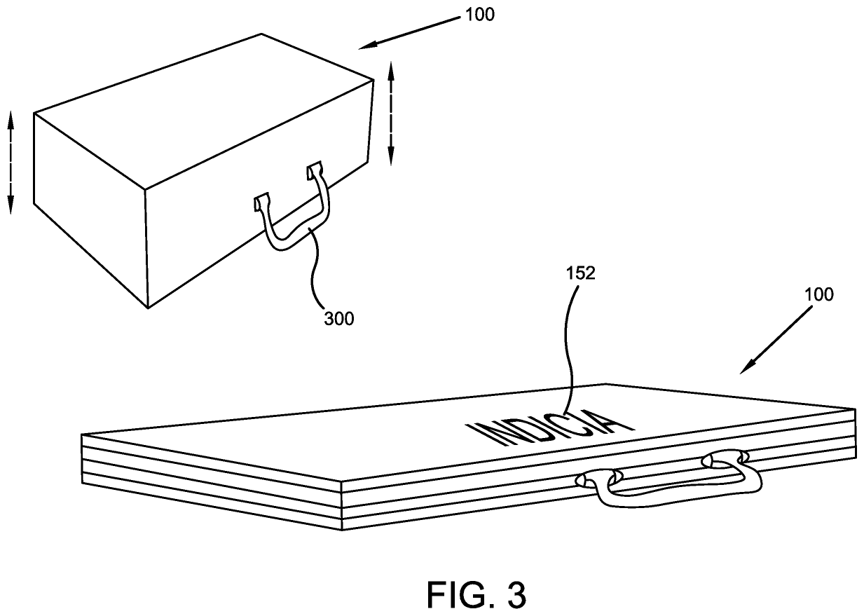

FIG. 3 illustrates a perspective view of another embodiment of the cat house device 100 of the present invention. In this embodiment, when not in use, the cat house device 100 is collapsible, such that the pop-up structure's walls fold in on each other, or coil together into a flat structure via the rod or multi-rod frame. Once collapsed, the cat house device 100 comprises at least one handle 300, secured to the back of a wall for easy transportation when carrying the device 100.

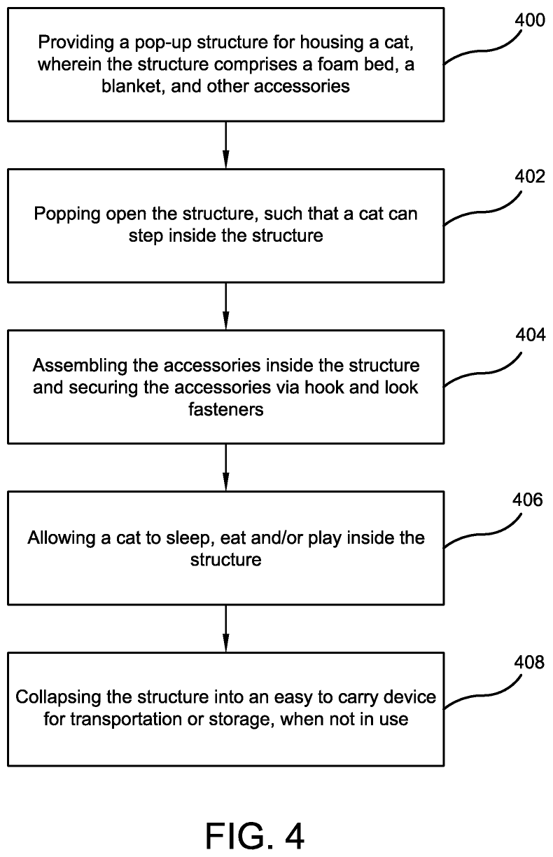

FIG. 4 illustrates a flowchart of the method of providing cats with a large, cozy housing area for sleeping, eating, and/or playing. The method includes the steps of at 400, providing a pop-up structure for housing the cat, wherein the structure comprises a foam bed, a blanket, and other accessories. The method also comprises at 402, popping open the structure, such that a cat can sleep inside the structure. Further, the method comprises at 404, assembling the accessories inside the structure and securing the accessories via hook and loop fasteners. The method comprises at 406, allowing a cat to sleep, eat, and/or play inside the structure. Finally, at 408, collapsing the structure into an easy to carry device for transportation and/or storage, when not in use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cat house device” and “device” are interchangeable and refer to the cat house device 100 of the present invention. Of course the device of the present invention is not limited to use by cats and may be used by other pets, such as dogs.

Notwithstanding the foregoing, the cat house device 100 of the present invention can be of any suitable size and configuration as is known in the art without affecting the overall concept of the invention, provided that it accomplishes the above-stated objectives. One of ordinary skill in the art will appreciate that the cat house device 100 as shown in FIGS. 1-4 is for illustrative purposes only, and that many other sizes and shapes of the cat house device 100 are well within the scope of the present disclosure. Although the dimensions of the cat house device 100 are important design parameters for user convenience, the cat house device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cat house device that provides a cat with a large, cozy housing area for sleeping, eating, and/or playing, the cat house device comprising:
a pop-up structure; and
a plurality of accessories positioned inside the pop-up structure, wherein the pop-up structure can be expanded for use and collapsed into a compact device when not in use, and further wherein the pop-up structure houses a cat.

2. The cat house device of claim 1, wherein the pop-up structure is rectangular in shape.

3. The cat house device of claim 2, wherein the pop-up structure comprises a multi-rod frame arranged with a plurality of connectors and an attached fabric structure.

4. The cat house device of claim 3, wherein the pop-up structure is self-erecting and foldable when not in use.

5. The cat house device of claim 2, wherein the pop-up structure comprises a set of four rigid walls secured to a pair of opposing sides of a rectangular floor component.

6. The cat house device of claim 5, wherein the set of four rigid walls are folded in on each other to collapse the pop-up structure.

7. The cat house device of claim 6, wherein when the set of four rigid walls are erect they are secured in a substantially vertical position via a plurality of flaps.

8. The cat house device of claim 2, wherein the pop-up structure comprises a flexible base with a set of four rigid walls secured to the base.

9. The cat house device of claim 8, wherein at least two of the set of four rigid walls comprise a crease, which allows those two walls to fold in on themselves, and a remainder of the set of four rigid walls to lay flat on the folded walls, thereby compressing the pop-up structure.

10. The cat house device of claim 9 wherein once erect, the set of four rigid walls are held in a substantially vertical position via a rigid floor component that overlays the flexible base to provide rigidity to the pop-up structure and retain the set of four rigid walls in the substantially vertical position.

11. The cat house device of claim 1, wherein the plurality of accessories comprises a foam bed, a blanket, a foam dresser, a battery-operated lamp, a scratchy rug, a swinging door, a plurality of windows, a food bowl and a water bowl.

12. The cat house device of claim 11, wherein the plurality of accessories are secured via hook and loop fasteners.

13. The cat house device of claim 12 further comprising a plurality of decorations.

14. The cat house device of claim 12, wherein the plurality of decorations are secured via hook and loop fasteners.

15. A cat house device that provides a cat with a large, cozy housing area for sleeping, eating, and/or playing, the cat house device comprising:
a pop-up structure for housing the cat; and
a plurality of accessories positioned inside the pop-up structure;
wherein the pop-up structure can be expanded for use and collapsed into a compact device when not in use;
wherein the pop-up structure comprises a set of four rigid walls secured to opposing sides of a rectangular floor component;
wherein the four rigid walls are folded in on each other to collapse the pop-up structure;
wherein when the four rigid walls are erect, they are secured in a substantially vertical position via flaps; and
further wherein the plurality of accessories comprises a foam bed, a blanket, a foam dresser that holds cat toys, a battery-operated lamp, a scratchy rug, a swinging door, a plurality of windows, a food bowl and a water bowl.

16. The cat house device of claim 15, wherein the plurality of accessories are secured to the pop-up structure via hook and loop fasteners.

17. The cat house device of claim 15 further comprising a plurality of decorations secured to the pop-up structure via hook and loop fasteners.

18. The cat house device of claim 15, wherein the pop-up structure comprises a ceiling component that encloses the pop-up structure.

19. The cat house device of claim 15 wherein the pop-up structure comprises an indicia.

20. A method of providing a cat with a large, cozy housing area for sleeping, eating, and/or playing, the method comprising the steps of:
providing a pop-up structure for housing the cat, wherein the pop-up structure comprises a foam bed, a blanket and a plurality of accessories;
popping open the pop-up structure, such that the cat can be within the pop-up structure;
assembling the plurality of accessories inside the pop-up structure;
securing the plurality of accessories to the pop-up structure via hook and loop fasteners;
allowing the cat to sleep, eat, and/or play inside the pop-up structure; and
collapsing the pop-up structure when not in use.
